(19) United States
(12) Patent Application Publication
(10) Pub. No.: US 2019/0120065 A1
(43) Pub. Date: Apr. 25, 2019

(54) TURBINE BLADE

(71) Applicant: DOOSAN HEAVY INDUSTRIES & CONSTRUCTION CO., LTD., Changwon-si (KR)

(72) Inventor: Jin Uk Kim, Seoul (KR)

(21) Appl. No.: 16/122,885

(22) Filed: Sep. 6, 2018

(30) Foreign Application Priority Data
Oct. 25, 2017 (KR) 10-2017-0139308

(51) Int. Cl. F01D 5/18; F01D 5/14

(52) U.S. Cl. CPC F01D 5/186; F01D 5/143; F05D 2260/202; F05D 2250/74; F05D 2240/301; F05D 2240/305; F05D 2250/141

(57) ABSTRACT

A turbine blade can shorten the assembly time of a multistage turbine section of a gas turbine and reduce assembly errors such as misalignment between adjacent turbine blades, while minimizing the occurrence of a secondary vortex. The turbine blade includes a main end wall; a first turbine airfoil that is connected on a hub side to the main end wall and has a leading edge and a trailing edge; and a second turbine airfoil that is connected on a hub side to the main end wall and has a leading edge and a trailing edge, wherein the main wall is integrally formed with each of the first and second turbine airfoils. The second turbine airfoil is disposed on the main end wall so as to face the first turbine airfoil, and the main end wall is disposed between the first turbine airfoil and the second turbine airfoil.

### CROSS REFERENCE TO RELATED APPLICATION

The present application claims priority to Korean Patent Application No. 10-2017-0139308, filed Oct. 25, 2017, the entire contents of which is incorporated herein for all purposes by this reference.

### BACKGROUND OF THE INVENTION

### 1. Field of the Invention

The present invention relates to a component of a gas turbine and, more particularly, to a turbine blade set in which multiple turbine blades to come into contact with hot gas are integrated to ensure structural stability and integrity of a turbine.

### 2. Description of the Background Art

Generally, a gas turbine is known as a kind of combustion engine that converts thermal energy into mechanical energy by compressing air with a compressor to produce a high pressure compressed air, mixing fuel with the compressed air, burning the resulting fuel and air mixture to produce a hot, high pressure combustion gas, and jetting the combustion gas to a turbine, thereby rotating the turbine.

One of the most widely used turbines is structured such that a plurality of turbine rotor disks are arranged in multiple stages, a plurality of turbine blades are fixed or retained to the outer circumferential surface of each turbine rotor disk, and a hot, high pressure combustion gas flows through blade passages.

Assembling a turbine section of a gas turbine takes a long time, and assembly errors occur, because a large number of turbine blades need to be joined to produce a multistage turbine. Meanwhile, if a radial height difference is present among turbine blades or if turbine blades are arranged at irregular pitches in a turbine, a problem associated with a secondary vortex occurs when hot gas passes through turbine blade passages. That is, when hot gas passes along a flow path between turbine blades, a secondary vortex is likely to occur, which is a major source of an aerodynamic loss at the suction side or the pressure side of a turbine blade.

This aerodynamic loss deteriorates the efficiency of a gas turbine. For this reason, a countermeasure for securing a stable hot gas flow is needed.

### SUMMARY OF THE INVENTION

Accordingly, it is an object of the present invention to provide a turbine blade in which the assembly time of a multistage turbine section of a gas turbine is shortened and in which assembly errors such as misalignment between adjacent turbine blades are reduced while minimizing the occurrence of a secondary vortex.

In one embodiment, a turbine blade may include a main end wall; a first turbine airfoil that is connected on a hub side to the main end wall and has a leading edge and a trailing edge; and a second turbine airfoil that is connected on a hub side to the main end wall and has a leading edge and a trailing edge, wherein the main wall is integrally formed with each of the first and second turbine airfoils.

The second turbine airfoil may be disposed on the main end wall so as to face the first turbine airfoil, and the main end wall may be disposed between the first turbine airfoil and the second turbine airfoil.

The main end wall disposed between the first turbine airfoil and the second turbine airfoil may include an inclined portion that is inclined in a pitch-wise direction that is a direction toward the second turbine airfoil from the first turbine airfoil, and a curved portion having a streamlined profile extending in a pitch-wise direction that is a direction toward the second turbine airfoil from the first turbine airfoil. The curved portion may have a curvature that varies along the pitch-wise direction.

The first turbine airfoil may include a suction side surface, and the curved portion of the main end wall in a region near the suction side surface may be first downwardly curved and then upwardly curved along a direction in which hot gas flows within a blade passage ranging from the leading edge to the trailing edge of the first turbine airfoil. The blade passage may range from the leading edges to the trailing edges, and the curved portion along the blade passage may be first upwardly curved from a certain position in a gas flow direction and may be then gradually downwardly curved with a decreasing distance to the trailing edge of one of the first and second turbine airfoils. The curved portion may be provided in a middle portion of the blade passage.

The curved portion provided between the first turbine airfoil and the second turbine airfoil may have a protruding portion on a flow path of hot gas. The protruding portion may have a circular bar shape elongated by a predetermined length and having a circular cross section, or an embossed shape.

According to another aspect of the present invention, there is provided a gas turbine including a turbine blade that may include the above-described main end wall. The gas turbine may further include a multi-stage turbine, and the main end wall may be provided in only a third turbine stage through a last turbine stage.

In another embodiment, a turbine blade may include a main end wall; a first turbine airfoil that is connected on a hub side to the main end wall and has a leading edge and a trailing edge; a second turbine airfoil that is connected on a hub side to the main end wall and has a leading edge and a trailing edge; and side end walls respectively extending outward in a horizontal direction from a suction side surface of the first turbine airfoil and from a pressure side surface of the second turbine airfoil. The first and second turbine airfoils, the main end wall, and the side end walls may be integrally formed.

The turbine blade may further include a first feeder formed in the main end wall and configured to feed coolant toward the first turbine airfoil; and a second feeder formed in one of the side end walls and configured to feed coolant toward the second turbine airfoil. Each of the first and second feeders may include openings respectively directed at the leading edges of the first and second turbine airfoils.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a cross-sectional view of a gas turbine including turbine blades;

FIG. 2 is a perspective view illustrating a turbine blade and an end wall according to a first embodiment of the present invention;

FIG. 3 is a front view illustrating a main end wall of the turbine blade and the main end wall according to the first embodiment;

FIG. 4 is a view illustrating a turbine blade, a main end wall, and a side end wall according to a second embodiment of the present invention;

FIG. 5 is a view illustrating a turbine blade, a main end wall, and a side end wall according to the second embodiment of the present invention; and

FIG. 6 is a view illustrating an assembled structure of the turbine blade according to the second of the present invention.

### DETAILED DESCRIPTION OF THE DISCLOSURE

The basic structure of a gas turbine according to a first embodiment of the present invention will be described with reference to the accompanying drawings.

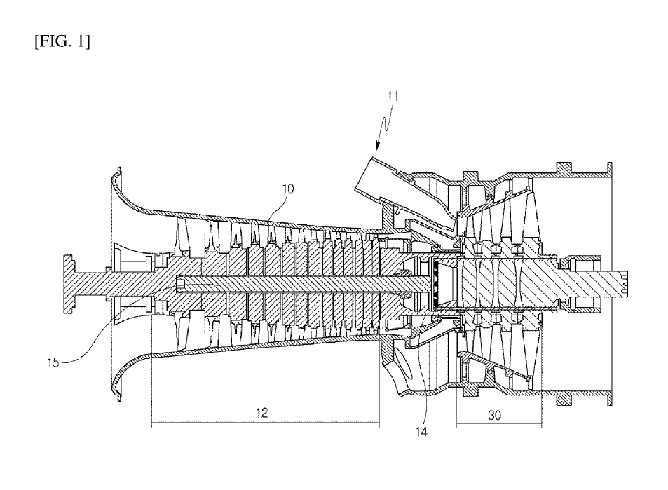

Referring to FIG. 1, a gas turbine includes a casing 10 that is an outer shell of the gas turbine, and a diffuser through which combustion gas passing through a turbine is discharged. The diffuser is disposed at the rear side of the casing 10 (i.e., the right side of FIG. 1).

A combustor 11 that burns a mixture of fuel and compressed air is disposed at the front side of the diffuser.

In terms of flow directionality, a compressor section 12 is disposed at the upstream side of the casing 10, and a turbine section 30 is disposed at the downstream side of the casing 10.

A torque tube 14 for transferring torque generated in the turbine section 30 to the compressor section 12 is installed between the compressor section 12 and the turbine section 40.

The compressor section 12 includes multiple (for example, fourteen) compressor rotor disks. The compressor rotor disks are attached to a tie road 15 so as not to be separated from each other in an axial direction.

The tie rod 15 is installed to extend in the axial direction and to pass through central holes of the compressor rotor disks that are arranged in the axial direction. Each compressor rotor disk has a flange protruding in the axial direction at a position near the outer periphery of the compressor rotor disk so that each compressor rotor disk is locked to prevent rotation relative to the adjacent compressor rotor disk.

Multiple blades are radially retained to the outer circumferential surface of each compressor rotor disk. Each blade has a dovetail which is fitted in a corresponding slot formed in the outer surface of the corresponding rotor disk.

The dovetail may be either a tangential entry type or an axial entry type. Choice of the tangential entry type or the axial entry type may be determined depending on the structure of any given gas turbine. Alternatively, the blades may retained to the rotor disk by a different coupling means.

The tie rod 15 is installed to pass through center holes of the multiple compressor rotor disks, in which one end of the tie rod 15 is coupled to the farthest upstream rotor disk and the other end may be fixed to the torque tube.

The structure of the tie rod may vary according to the type of gas turbine. Therefore, it should be noted that the structure of the tie rod is not limited to the example illustrated in the drawings.

For example, a single tie rod (called single-type) may be installed to pass through all of the center holes of the rotor disks. Alternatively, multiple tie rods (called multi-type) may be arranged in a circumferential direction. Further alternatively, a complex type employing both the single-type and the multi-type may be used.

Although not illustrated in the drawings, the compressor section of the gas turbine is provided with a vane (also called a guide vane) next to the diffuser. The guide vane adjusts the flow angle of a high pressure fluid exiting the compressor section and flowing into the combustor section such that the actual flow angle of the fluid matches with the designed flow angle. This vane is generally referred to as a deswirler.

The combustor 11 mixes the introduced compressed air with fuel and burns the fuel-air mixture to produce a hot, high pressure combustion gas which is then heated through an isobaric combustion process to the heat-resist temperature limits of components of the combustor and the turbine.

The combustion section of the gas turbine may consist of multiple combustors provided in a cell-type casing. Each of the combustors includes a burner having a fuel injection nozzle and the like, a combustor liner defining a combustion chamber (i.e., combustion zone), and a transition piece serving as a connection member that connects the combustor liner and the turbine section.

Particularly, the combustor liner defines the combustion chamber in which the fuel injected through the fuel injection nozzle and the compressed air fed from the compressor are mixed and burned. In the combustion chamber defined by the combustor liner, a fuel and air mixture is combusted. A flow sleeve is installed to surround the combustor liner and the transition piece, thereby providing an annulus space between the combustor liner and the flow sleeve and between the transition piece and the flow sleeve. A fuel nozzle assembly is coupled to a front end (i.e., upstream end) of the combustor liner, and a spark igniter plug is coupled to the side surface of the combustor liner.

The transition piece is connected to a rear end (i.e., downstream end) of the combustor liner to deliver the combustion gas, produced in the combustion chamber after the flame is started by the spark igniter plug, to the turbine section.

In order to prevent the transition piece from being damaged, a portion of the compressed air is fed from the compressor to the outer wall of the transition piece so that the outer wall of the transition piece can be cooled.

To this end, the transition piece is provided with cooling holes through which the compressed air (called coolant) is introduced to cool the body of the transition piece, and then the coolant flows toward the combustor liner.

The coolant used for cooling the transition piece then flows to the combustor liner through the annulus space. A portion of the compressed air is externally introduced into the annulus space through cooling holes formed in the flow sleeve and this air may collide against the outer surface of the combustor liner.

In the turbine section, the hot, high pressure combustion gas delivered from the combustor expands and then impinges on the turbine blades or glides over the turbine blades, causing rotary movement (mechanical energy).

A portion of the mechanical energy generated in the turbine section is used to drive the compressor to compress air and the remaining mechanical energy is used to drive an electric generator to produce electricity.

In the turbine casing, stator vanes and rotor blades are alternately arranged. The combustion gas drives the turbine rotor blades, which in turn rotate and drive the output shaft to which the electric generator is connected.

To this end, the turbine section 30 includes multiple turbine rotor disks. Turbine rotor disks have the substantially same shape as the compressor rotor disks.

The turbine rotor disk is combined with the adjacent rotor disk by a flange, and a plurality of turbine blades are radially retained to the outer circumferential surface of the turbine rotor disk. Each of the turbine blades may be retained to the turbine rotor disks by a dovetail.

In the gas turbine having the structure described above, the intake air is compressed in the compressor section 12, then burned in the combustor 11, then fed to the turbine section 30 to drive the turbine, and finally discharged to the atmosphere via the diffuser.

A typical method of improving the performance of a gas turbine is to increase the temperature of the combustion gas entering the turbine section 30. However, in this case, the inlet temperature of the turbine section 30 rises.

In this case, the turbine blades in the turbine section 30 come into trouble. That is, as the temperature of the turbine blades locally rises, thermal stress occurs. When this thermal stress lasts for a long period, the turbine blades may experience a creep phenomenon, which results in the fracture of the turbine blades.

A turbine blade provided in a gas turbine, according to a first embodiment of the present invention, will be described below with reference to the accompanying drawings.

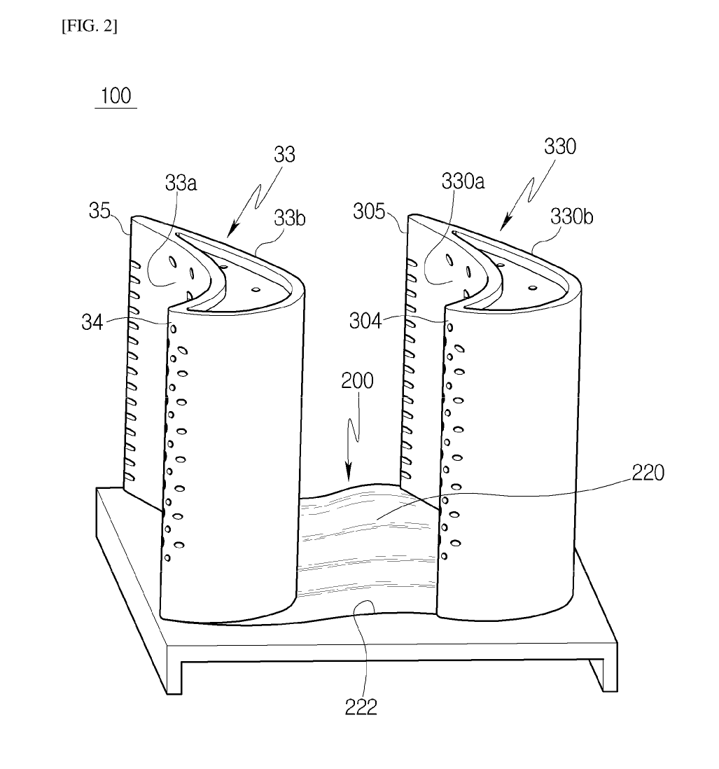

Referring to FIGS. 2 to 4, the turbine blade 100 according to the first embodiment of the present invention includes a first turbine airfoil 33 and a second turbine airfoil 330 and a main end wall 200 disposed between and connected to the first turbine airfoil 33 and the second turbine airfoil 330 in which the first and second turbine airfoils 33 and 330 and the main end wall 200 are integrated to form one body. Therefore, stable cooling of the outer circumferential surface is accomplished when hot gas is supplied to the outer circumferential surface of the turbine blade. Since the first turbine airfoil 33 and the second turbine airfoil 330 are not discretely fabricated but are integrally formed, the radial height difference between the first turbine airfoil 33 and the second turbine airfoil 330 may not occur and the speed and workability in an assembly process are improved.

To this end, the turbine blade 100 according to the present embodiment includes the first turbine airfoil 33 having a leading edge 34 and a trailing edge 35, the second turbine airfoil 330 disposed to face the first turbine airfoil 33 and having a leading edge and a trailing edge, the main end wall 200 disposed between and connected to the first turbine airfoil 33 and the second turbine airfoil 330, in which the first and second turbine airfoils 33 and 330 and the main end wall 200 are integrally formed.

The turbine blade 100 according to the present embodiment can be applied to a gas turbine having turbine blades respectively provided with a main end wall. However, the application of the present embodiment is not limited thereto. That is, the turbine blade 100 according to the present embodiment also may be applied to a turbine machine or other turbine-based apparatuses.

Each of the turbine stages except for a first turbine stage and a second turbine stage is provided with the main end wall 200. The span of a turbine blade, which is a radial height ranging from a hub to a tip of the turbine blade, is relatively short in the case of the first and second turbine stages compared to the other stages. When the shorter turbine blades of the first and second stages are met with hot gas, the hub, the shroud, and most of the entire span of the turbine blade are thermally affected by the hot gas. Therefore, a turbine blade cooling efficiency in the first and second stages is lower than that in the other stages.

The main end wall 200 provided to a turbine blade of a last stage turbine is hardly influenced by the hot gas. Therefore, it is preferable that the main end wall 200 is provided to the turbine blades in the latter stages of the turbine. Since the first turbine airfoil 33 and the second turbine airfoil 330 are combined by the main end wall 200, a turbine assembling efficiency is improved and an aerodynamic loss attributable to a coolant flow is reduced.

Since the main end wall 200 and the first and second turbine airfoils 33 and 330 are integrally formed, there is no assembling error in the junctions between the first turbine blade and the second turbine blade. Therefore, when the coolant moves along a blade passage between the first turbine airfoil 33 and the second turbine airfoil 330 along the surfaces of the first and second turbine airfoils 33 and 330, i.e., when the coolant moves from leading edges 34 and 304 to the trailing edges 35 and 305, flow separation is suppressed and thus a secondary vortex induced by the flow separation is weakened.

Secondary vortexes occur when hot gas moves along the pressure side surfaces 33a and 330a and the suction side surfaces 33b and 330b of the first and second turbine airfoils 33 and 330, and it is desirable that the secondary vortexes are minimal. In the present embodiment, since the main end wall 200 and the first and second turbine airfoils 33 and 330 are integrally formed, an unwanted secondary vortex associated with a hot gas flow is suppressed, and thus a problem associated with a passage vortex is suppressed.

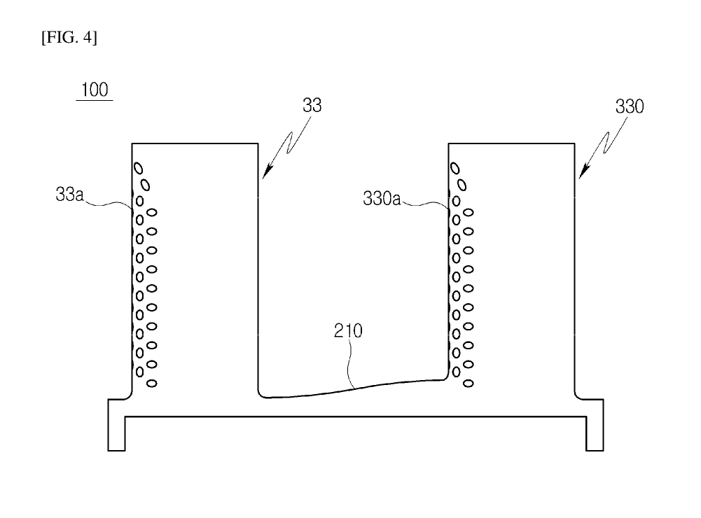

In the present embodiment, the main end wall 200 has an inclined portion 210 (see FIG. 4) having an upward slope toward the second turbine airfoil 330 from the first turbine airfoil 33. The inclined portion 210 is common to both the first and second embodiments, and though FIG. 4 is directed to the second embodiment, the inclined portion 210 present in either embodiment can be appreciated by referring to FIG. 4.

An inclination angle or profile of the inclined portion 210 is not limited to the example illustrated in FIG. 4 and may vary. As to the inclined portion 210, there may be various modifications in which the inclination angle may be larger or smaller than and the profile may be steeper or more gentle than those depicted in FIG. 4. The inclination angle or profile of the inclined portion may be determined so as to attain the flow stability of the hot gas flowing along the pressure side surface 330a of the second turbine airfoil 330 by reducing a secondary vortex of the hot gas.

In the present embodiment, the main end wall 200 between the first turbine airfoil 33 and the second turbine airfoil 330 includes a curved portion 220 having a streamlined profile extending toward the second turbine airfoil 330.

The curvature of the curved portion 220 of the main end wall between the first turbine airfoil 33 and the second turbine airfoil 330 is not uniform but varies according to location.

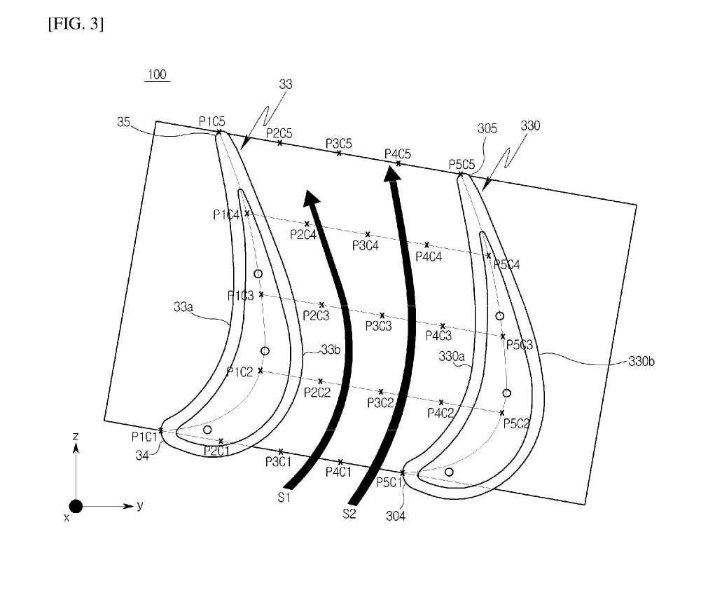

For an easy description of the curvature of the present embodiment, it is assumed the curved portion 220 between the first turbine airfoil 33 and the second turbine airfoil 330 is segmented by N points as illustrated in FIG. 3. X-axis, Y-axis, and Z-axis coordinates (values) of each point are shown in Table 1.

Although the number of segmentation points in FIG. 3 is set to a specific value in each of a vertical direction and a horizontal direction to facilitate description, these numbers may be changed and a distance between adjacent points may be increased or decreased to create a precise flow path.

TABLE 1

| | | x(mm) | y(mm) | z(mm) |
|---|---|---|---|---|
| P1 | C1 | −101.4 | 489.458 | 188.12 |
| P1 | C2 | −101.4 | 517.3 | 204.8 |
| P1 | C3 | −101.4 | 517.764 | 226.307 |
| P1 | C4 | −101.4 | 513.43 | 248.66 |
| P1 | C5 | −101.4 | 505.965 | 271.565 |
| P2 | C1 | −101.4 | 506.2 | 185.168 |
| P2 | C2 | −104.521 | 534.041 | 201.848 |
| P2 | C3 | −100.783 | 534.505 | 223.355 |
| P2 | C4 | −99.8172 | 530.171 | 245.708 |
| P2 | C5 | −101.4 | 522.706 | 268.613 |
| P3 | C1 | −101.4 | 522.942 | 182.216 |
| P3 | C2 | −101.262 | 550.783 | 198.896 |
| P3 | C3 | −105.84 | 551.247 | 220.403 |
| P3 | C4 | −104.681 | 546.913 | 242.756 |
| P3 | C5 | −101.4 | 539.448 | 265.661 |
| P4 | C1 | −101.4 | 539.683 | 179.264 |
| P4 | C2 | −100.361 | 567.525 | 195.944 |
| P4 | C3 | −104.692 | 567.989 | 217.451 |
| P4 | C4 | −107.537 | 563.655 | 239.804 |
| P4 | C5 | −101.4 | 556.19 | 262.709 |
| P5 | C1 | −101.4 | 556.425 | 176.312 |
| P5 | C2 | −101.4 | 584.267 | 192.992 |
| P5 | C3 | −101.4 | 584.731 | 214.499 |
| P5 | C4 | −101.4 | 580.397 | 236.852 |
| P5 | C5 | −101.4 | 572.932 | 259.757 |

Table 1 shows X-axis and Y-axis coordinate values and a Z-axis coordinate value (height) of each point illustrated in FIG. 3. For example, for a point P3C1, the Z-axis coordinate value is 182 mm. For a point P4C1 and a point P5C1, the Z-axis coordinate values are respectively 539 mm and 556 mm.

Within a range from the position P3C1 to the position P5C1, the Z-axis coordinate value increases as the distance to the point P5C1 decreases. Thus, in the range from the position P3C1 to the position P5C1, an upwardly streamlined curve is formed.

In a region near the suction side surface 33b of the first turbine airfoil 33, the surface contour of the curved portion 220 is first downwardly curved in a front-side low path along the flow direction of hot gas and is then upwardly curved in a rear-side flow path along the flow direction of hot gas.

Along the front flow path from the point P3C1 to P2C3 via P2C2, the surface contour is upwardly curved. Then, in the rear flow path, the surface contour is downwardly curved. At the points P3C1, P2C2, P2C3, P2C4, and P2C5, the Z-axis coordinate values are 522.9 mm, 534 mm, 534 mm, 530 mm, and 522 mm, respectively.

When a line is drawn to pass through the points P3C1, P2C2, P2C3, P2C4, and P2C5, a path having a streamlined shape is created. As the hot gas moves along a path S1, the hot gas glides along the curved surface of the curved portion 220 at a bottom span region. Therefore, an aerodynamic loss caused by a secondary vortex is reduced.

In the present embodiment, part of the curved portion 220 has an upwardly curved contour along the flow direction of hot gas, along a flow passage between the suction side surface 33b of the first turbine airfoil 33 and the pressure side surface 330a of the second turbine airfoil 330.

The curved portion has a downwardly curved contour section near the trailing edge 35 of the first turbine airfoil 33 and near the trailing edge 305 of the second turbine airfoil 330.

This downwardly curved contour section corresponds to a path S2 in FIG. 3. For points P4C1, P3C2, P3C3, P3C4, and P3C5, the Z-axis coordinate values are respectively 539 mm, 550 mm, 551 mm, 546 mm, and 529 mm.

With the coordinate values described above, the aerodynamic loss may be minimized even when a secondary vortex locally occurs.

The curved portion 220 provided between the first turbine airfoil 33 and the second turbine airfoil 330 has a protruding portion 222 that is provided somewhere on the flow path of the hot gas.

The protruding portion 222 functions to minimize the separation of the hot gas flow and may have a circular, an elliptical, or polygonal shape.

The protruding portion 222 may have a circular bar shape elongated by a predetermined length and having a circular cross section or an embossed shape.

When the protruding portion 222 has a bar shape, the hot gas may be guided to flow while being attached to the surface of the protruding portion. Thus, the hot gas flow is not detached from the surface of the curved portion 220 and is guided to stably flow along the surface of the curved portion 220.

The curved portion 220 is formed in a middle portion of the flow path extending from the leading edge 34/304 to the trailing edge 35/305 of the turbine airfoil 33/330.

The curved portion 220 is formed in a middle portion of a blade passage in a pitch-wise direction which is a direction toward the pressure side surface 330a of the second turbine airfoil 330 from the suction side surface 33b of the first turbine airfoil 33.

As the hot gas moves, an aerodynamic loss attributable to a secondary vortex is typically greatest in the region of the middle portion. Therefore, according to the present embodiment, the contour of the middle portion is changed as illustrated in the drawings to obtain the flow stability of the hot gas.

When the aerodynamic loss caused by a hot gas flow along the blade passage is reduced, the efficiency of the turbine blade can be increased and thus the power generation efficiency of a gas turbine can be increased.

Next, a turbine blade according to a second embodiment of the present invention will be described with reference to the accompanying drawings.

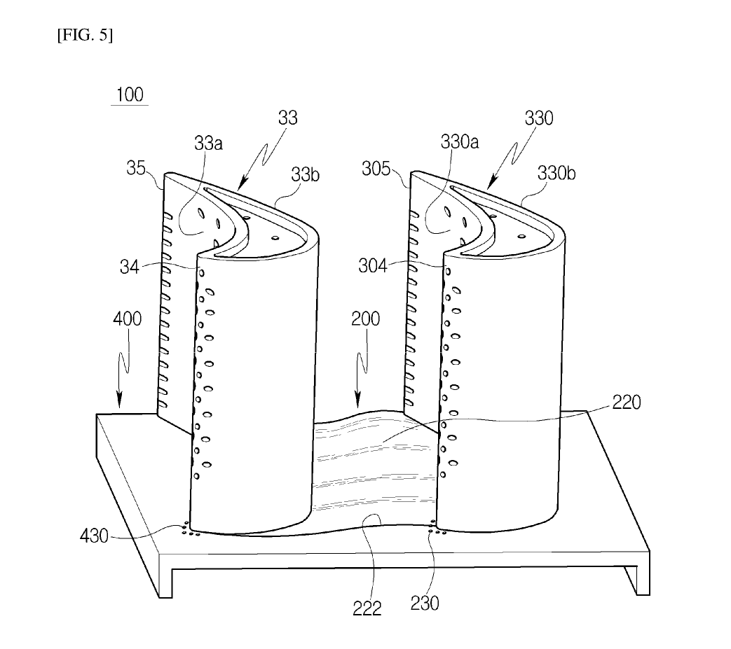

Referring to FIGS. 4 and 5, the turbine blade according to the second embodiment includes a first turbine airfoil 33 having a leading edge 34 and a trailing edge 35, a second turbine airfoil 330 disposed to face the first turbine airfoil 33 and having a leading edge and a trailing edge, a main end wall 200 disposed between and connected to the first turbine airfoil 33 and the second turbine airfoil 330, and side end walls 400 respectively extending outward in a horizontal direction from a pressure side surface 33a of the first turbine airfoil 33 and from a suction side surface 330b of the second turbine airfoil 330.

The second embodiment differs from the first embodiment in that the side end walls 400 are added to the configuration of the first embodiment. Thus, when one turbine blade is connected to a next turbine blade during an assembling process, a height difference or a pitch error between the assembled turbine blades can be minimized.

Turbine blades are assembled along a circumferential direction to form a ring shape. Therefore, when a radial height difference or a pitch difference between adjacent turbine blades occurs, it is difficult to obtain a smooth gas flow.

In order to solve this problem, the present embodiment uses the main end wall 200 and the side end walls 400, thereby improving the stability and structural integrity of turbine blades.

Particularly, the first and second turbine airfoils 33 and 330, the main end wall 200, and the side end walls 400 are integrally formed. For this reason, when a worker assembles a first stage of the turbine, since one turbine blade assembly consists of two turbine blades and side end walls 400 which are all integrated to form one body, an assembly error is reduced regardless of location in a circumferential direction and turbine blades can be combined in tight contact with each other.

The main end wall 200 may be provided with a first feeder 230 for feeding coolant to the first turbine airfoil 33 and the side end wall 400 may be provided with a second feeder 430 for feeding coolant to the second turbine airfoil 330.

The first and second feeders 430 and 230 have openings respectively directed at the leading edges 34 and 304 of the first and second turbine airfoils 33 and 330.

In order to minimize second vortexes when hot gas collides with the leading edges 34 and 304 and then moves toward the hubs or tips, the first and second feeders 230 and 430 turn the flow of the hot gas toward the pressure side surface 33a/330a or the suction side surface 33b/330b of the first or second turbine airfoil 33/330.

Thus, the flow separation of the hot gas is suppressed and the flow direction of the hot gas stabilized, resulting in improvement in aerodynamic performance.

The first and second feeders 430 and 230 receive coolant supplied via the side end walls 400 and the main end wall 200 and spray the coolant toward the pressure side surface 33a/330a or the suction side surface 33b/330b of the first or second turbine airfoil 33/330.

The first and second feeders 430 and 230 may spray the coolant in different directions so that a distribution angle can be increased. The number and arrangement of the first and second feeders is not limited to the example illustrated in the drawings.

Each of the first and second feeders 430 and 230 may have a round or slotted shape of a predetermined length, and the shape is not limited to the example illustrated in the drawings.

In the present embodiment, the main end wall 200 between the first turbine airfoil 33 and the second turbine airfoil 330 includes a curved portion 220 having a streamlined profile extending in a pitch-wise direction.

The curvature of the curved portion 220 varies along the pitch-wise direction toward the second turbine airfoil 330 from the first turbine airfoil 33.

In a region near the leading edge 34 of the first turbine airfoil 33, the curved portion 220 has a contour that is first downwardly curved and then upwardly curved along a blade passage that ranges from the leading edge 34 to the trailing edge 35 of the first turbine airfoil 33.

In a region near the leading edge 304 of the second turbine airfoil 330, the curved portion 220 has a contour that is first upwardly curved and then downwardly curved along a blade passage that ranges from the leading edge 304 to the trailing edge 305 of the second turbine airfoil 330.

The curved portion 220 is formed in a middle portion of the blade passage ranging from the leading edge 34 or 304 to the trailing edge 35 or 305 of the first turbine airfoil 33 or the second turbine airfoil 330.

The curved portion 220 is formed in a middle portion of the width of the blade passage ranging from the suction side surface 33b of the first turbine airfoil 33 to the pressure side surface 330a of the second turbine airfoil 330.

Generally, the middle portion is known as a region where, as the hot gas moves, an aerodynamic pressure loss attributable to a secondary vortex is greatest. Therefore, according to the present embodiment, the contour of the middle portion is changed as illustrated in the drawings to obtain the flow stability of the hot gas.

When the aerodynamic loss caused by the flow of the hot gas along the blade passage between the first turbine airfoil 33 and the second turbine airfoil 330 is reduced, the efficiency of the turbine blade can be increased and thus the power generation efficiency of the gas turbine can be increased.

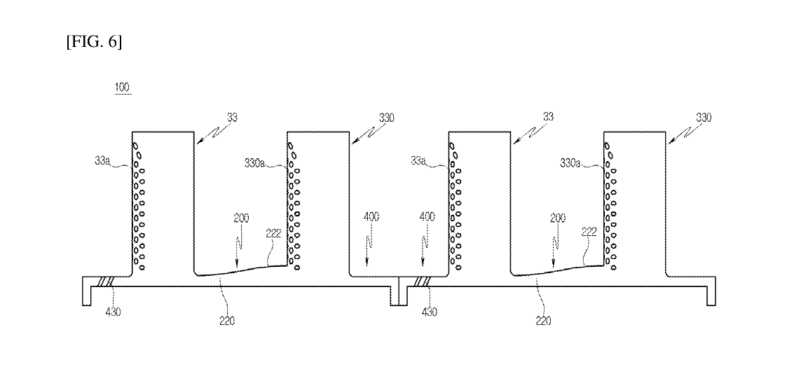

Referring to FIG. 6, when a worker assembles a turbine by combining the first turbine airfoil 33 and the second turbine airfoil 330 to be in tight contact with each other, positioning errors are minimized because positioning alignment can be achieved by mating the side end walls 400 with each other.

Therefore, when hot gas flows along the surface of the main end wall 200 or the side end wall 400, a gas flow toward a gap between turbine blades does not occur and an aerodynamic loss caused by a secondary vortex is minimized.

While the present disclosure has been described with respect to the specific embodiments, it will be apparent to those skilled in the art that various changes and modifications may be made without departing from the spirit and scope of the disclosure as defined in the following claims.

What is claimed is:

1. A turbine blade comprising:
a main end wall;
a first turbine airfoil that is connected on a hub side to the main end wall and has a leading edge and a trailing edge; and
a second turbine airfoil that is connected on a hub side to the main end wall and has a leading edge and a trailing edge,
wherein the main wall is integrally formed with each of the first and second turbine airfoils.

2. The turbine blade according to claim 1, wherein the second turbine airfoil is disposed on the main end wall so as to face the first turbine airfoil.

3. The turbine blade according to claim 1, wherein the main end wall is disposed between the first turbine airfoil and the second turbine airfoil.

4. The turbine blade according to claim 3, wherein the main end wall disposed between the first turbine airfoil and the second turbine airfoil include an inclined portion that is inclined in a pitch-wise direction that is a direction toward the second turbine airfoil from the first turbine airfoil.

5. The turbine blade according to claim 3, wherein the main end wall disposed between the first turbine airfoil and the second turbine airfoil includes a curved portion having a streamlined profile extending in a pitch-wise direction that is a direction toward the second turbine airfoil from the first turbine airfoil.

6. The turbine blade to claim 5, wherein the curved portion has a curvature that varies along the pitch-wise direction.

7. The turbine blade according to claim 5, wherein the first turbine airfoil includes a suction side surface, and the curved portion of the main end wall in a region near the suction side surface is first downwardly curved and then upwardly curved along a direction in which hot gas flows within a blade passage ranging from the leading edge to the trailing edge of the first turbine airfoil.

8. The turbine blade according to claim 5, wherein the main end wall includes a blade passage between a suction side surface of the first turbine airfoil and a pressure side surface of the second turbine airfoil, the blade passage ranging from the leading edges to the trailing edges, and
wherein the curved portion along the blade passage is first upwardly curved from a certain position in a gas flow direction and is then gradually downwardly curved with a decreasing distance to the trailing edge of one of the first and second turbine airfoils.

9. The turbine blade according to claim 8, wherein the curved portion is provided in a middle portion of the blade passage.

10. The turbine blade to claim 5, wherein the curved portion provided between the first turbine airfoil and the second turbine airfoil has a protruding portion on a flow path of hot gas.

11. The turbine blade according to claim 10, wherein the protruding portion has a circular bar shape elongated by a predetermined length and having a circular cross section, or an embossed shape.

12. The turbine blade according to claim 1, further comprising side end walls respectively extending outward in a horizontal direction from a suction side surface of the first turbine airfoil and from a pressure side surface of the second turbine airfoil.

13. A gas turbine comprising a turbine blade comprising the main end wall according to claim 1.

14. The gas turbine according to claim 13, further comprising a multi-stage turbine,
wherein the main end wall is provided to a turbine blade of each of a third turbine stage through a last turbine stage of the multi-stage turbine, and is not provided in a first stage turbine stage and a second turbine stage of the multi-stage turbine.

15. A turbine blade comprising:
a main end wall;
a first turbine airfoil that is connected on a hub side to the main end wall and has a leading edge and a trailing edge;
a second turbine airfoil that is connected on a hub side to the main end wall and has a leading edge and a trailing edge; and
side end walls respectively extending outward in a horizontal direction from a suction side surface of the first turbine airfoil and from a pressure side surface of the second turbine airfoil.

16. The turbine blade according to claim 15, wherein the first and second turbine airfoils, the main end wall, and the side end walls are integrally formed.

17. The turbine blade according to claim 15, wherein the second turbine airfoil is disposed on the main end wall so as to face the first turbine airfoil.

18. The turbine blade according to claim 15, wherein the main end wall is disposed between the first turbine airfoil and the second turbine airfoil.

19. The turbine blade according to claim 15, further comprising:
a first feeder formed in the main end wall and configured to feed coolant toward the first turbine airfoil; and
a second feeder formed in one of the side end walls and configured to feed coolant toward the second turbine airfoil.

20. The turbine blade according to claim 19, wherein each of the first and second feeders includes openings respectively directed at the leading edges of the first and second turbine airfoils.
